(19) United States
(12) Patent Application Publication
(10) Pub. No.: US 2026/0364905 A1
(43) Pub. Date: Nov. 19, 2026

(54) MANUFACTURING INSTALLATION FOR BELT AND/OR CARCASS BAND IN THE TIRE INDUSTRY, METHOD FOR MONITORING SUCH A MANUFACTURING INSTALLATION, COMPUTER PROGRAM AND ELECTRONICALLY READABLE DATA CARRIER

(71) Applicant: Fischer TireTech Germany GmbH, Burgkunstadt (DE)

(72) Inventor: Frank SCHMIDT, Thurnau (DE)

(21) Appl. No.: 19/673,359

(22) Filed: May 11, 2026

(30) Foreign Application Priority Data
May 15, 2025 (DE) 10 2025 118 823.8

(51) Int. Cl. B29D 30/00

(52) U.S. Cl. CPC B29D 30/0016

(57) ABSTRACT

A manufacturing installation for belt and/or carcass band, having a plurality of material-processing and/or material-conveying manufacturing components controllable depending on operating parameters, a control device controlling the manufacturing components, and an operating device. The control device has a monitoring device for monitoring operation of the manufacturing components, including a component for carrying out individual steps of a cycle for acting on the material. A cycle time recording device is provided on the manufacturing component to be monitored to record cycle time of the cycle. The monitoring device has: a monitoring unit for evaluating cycle times recorded by the recording device relative to fulfilment of a measure condition which indicates presence of an anomaly in the manufacturing process, and a measure unit for carrying out a control measure assigned to a fulfilled measure condition and relates to an output of an indication of presence of the corresponding anomaly and/or an intervention in the manufacturing process related to the anomaly.

### CROSS-REFERENCE TO RELATED APPLICATIONS

The present application claims priority of DE 10 2025 118 823.8, filed May 15, 2025, the priority of this application is hereby claimed, and this application is incorporated herein by reference.

### BACKGROUND OF THE INVENTION

The invention relates to a manufacturing installation for belt and/or carcass band in the tire industry, having a plurality of material-processing and/or material-conveying manufacturing components which are controllable depending on operating parameters, a control device for controlling the manufacturing components, and an operating device, wherein the control device has a monitoring device for monitoring the operation of at least one manufacturing component to be monitored from among the manufacturing components, comprising at least one individual-step component for carrying out individual steps of a cycle for acting on the material. In addition, the invention relates to a computer-implemented method for monitoring such a manufacturing installation, a computer program and an electronically readable data carrier.

Manufacturing installations in which a starting band, in particular a tacky cord band, is processed into an endless band as a manufacturing product, which is used as belt band or carcass band in the tire industry, are generally known in the prior art. Depending on the intended use, they may also be referred to as a belt installation or carcass installation. The manufacturing installation may also be understood generally as a machine or device for processing a cord band in the tire industry. Band sections are severed from the starting band, in particular the tacky cord band, be this a textile cord band or a steel cord band, and an endless band is manufactured by splicing. The starting band is usually wound into a roll and received in an unwinding station, from which it is unwound and initially supplied to scissors, i.e. a cutting device, in which individual band sections are cut from the starting band. Such a cutting device is known for example from DE 20 2013 103 082 U1. The leading edge of the starting band is detected using a conveying device designed as a retraction device, which may also be referred to as a feed device and may have pliers, for example, and said leading edge is pulled through the cutting apparatus, for example guillotine scissors comprising a fixed lower blade and a movable upper blade, wherein the width of the band section to be cut is defined by the pulling length. Such a conveying device or pliers or conceivable subcomponents thereof are described for example in DE 20 2013 102 341 U1 and DE 101 13 379 A1. The cut band section can be moved by means of a receiving device to the level of a splicing device, as described for example in DE 20 2005 011 692 U1. Said cut band section is received by a conveyor belt as a further conveying device, via which the starting band is pulled before being cut by way of the retraction device, i.e. the pliers, and via which conveyor belt the respectively cut band section is transported to the splicing device, in which the cut band sections are spliced together to form an endless band, but with a different orientation compared to the starting band. In the splicing device, the trailing edge of the band section previously spliced to the endless band and the leading edge of the band section conveyed by the conveyor belt are positioned in relation to one another, after which the two edges are spliced together by way of a splicing apparatus of the splicing device. The splicing apparatus for this purpose has for example a splicing tool, which may comprise one splicing head or multiple splicing heads. The splicing head or splicing heads are in this case fed from above to the edges previously positioned in respect of one another. Following the respective placement of the splicing heads, pulling is carried out linearly along the splicing line, in the pressed state, over the band material in the direction of the lateral band edges over the band material. The splicing heads may run loose or be driven. During pulling over the band material, the latter is compacted and thus spliced. It is thereby possible to produce an endless band by splicing together a large number of individual band sections. Such a splicing device is known for example from DE 20 2014 101 735 U1.

In a winding station, the manufacturing product may then be wound up, wherein, downstream of the splicing device, further manufacturing components may optionally be provided in order to process the spliced-together endless band. By way of example, the manufacturing installation may comprise a slitter and/or a covering apparatus. A rubberized band may be applied to the cord band as a spliced-together endless band in a covering apparatus. Such a covering station has the task of reinforcing the produced material web, in this case the spliced-together cord band, during the manufacturing process with additional material strips. In this case, rubber profile strips are applied centrally and/or with an offset to the material web to be reinforced in the material conveying direction. This process runs continuously at the speed of the installation. The application may be carried out from above and/or from below. Furthermore, the outer edges of the material web are often edged, i.e. a rubber strip is applied from the outer edge with an overhang and laid around the rubber edge in order to cover the cord threads exposed at the outer edge (=cutting edge). A covering apparatus is disclosed by way of example by DE 20 2014 101 731 U1.

The slitter manufacturing component is a longitudinal cutting apparatus, that is to say the material web, in this case the spliced-together endless band, is separated into at least two material strips in the production process if required. It is used to increase the output of a manufacturing installation. Circular blades are usually used as slitter blades. The separation process is cutting of the material web. In practice, the term “slitting” is used. The slitter manufacturing component is designed to separate a supplied endless band into at least two or more band strips. The material web is cut here into defined material widths, which yield the same or different band strips. Slitters are described for example in DE 20 2013 104 649 U1, DE 20 2013 104 651 U1 and DE 20 2013 104 653 U1.

The description of a manufacturing product that is to be manufactured in a manufacturing process by way of such a manufacturing installation is specified by an operating parameter set of operating parameters that are unchangeable for this manufacturing process, which is usually referred to as a recipe or MES. In addition to a general recipe identification (recipe ID), a recipe may for example comprise the cutting angle to be applied in the scissors and the desired width of the material webs obtained as belt band or carcass band. The recipe may also describe a type of starting band to be used. A recipe is thus described mainly by the requirements placed on the manufacturing product, and is independent of the specific manufacturing installation. However, it may contain requirements placed on manufacturing speed and/or output, i.e. the quantity produced per unit of time.

If a problem occurs during the production of a belt or carcass band, for example a malfunction, damage and/or wear to a manufacturing component, restricted sensor data acquisition, a control error or the like, various undesired effects may occur. While in less problematic cases the output may be significantly reduced, for example, such deviations from the proper course of a manufacturing process frequently also lead to production of rejects or in rare cases even to, possibly further, damage to a manufacturing component. It is therefore known for a user to monitor the operation of manufacturing installations regularly or permanently during a manufacturing process, possibly assisted by sensor systems that can detect deviations from the desired manufacturing result, for example. A fine setting and optimization of the manufacturing process take place by means of visual observation by a user, and consequently in a user-dependent manner, since perception often varies. For many adaptations of operating parameters, the manufacturing installations have to be shut down, which also applies to checking in the event of potential problems. Accurate manual recording during the manufacturing process proves to be difficult. In addition, the different interplay and the optimization of individual components on account of frequent recipe changes, i.e. changes in the product to be manufactured, are extremely varied. Therefore, early detection of deviations during the manufacturing process by the user is additionally made more difficult. Predictive maintenance is not possible.

### SUMMARY OF THE INVENTION

The invention is therefore based on the object of specifying easily implementable, highly accurate and robust monitoring of the operation of a manufacturing installation for belt and carcass band in the tire industry.

In order to achieve this object, in a manufacturing installation of the type mentioned in the introduction, provision is made according to the invention for at least one cycle time recording means for recording a cycle time of the cycle to be provided on the manufacturing component to be monitored, and for the monitoring device to have:
a monitoring unit for evaluating cycle times recorded by the cycle time recording means with regard to the fulfilment of at least one measure condition which indicates the presence of an anomaly in the manufacturing process, and
a measure unit for carrying out at least one control measure which is assigned to a fulfilled measure condition and relates to an output of an indication of the presence of the corresponding anomaly and/or an intervention in the manufacturing process related to the anomaly.

The operation of the manufacturing installation during the manufacturing process is described by operating parameters, wherein fixed and settable operating parameters are usually present. The attribute “settable” for operating parameters is understood here to mean that the value of the operating parameter may be changed during the manufacturing process of a specific manufacturing product, i.e. an endless belt band or endless carcass band, able to be described by default parameters. These are in particular operating parameters that are able to be set within what is known as a recipe. A recipe basically comprises operating parameters that are independent of the specific manufacturing installation, which at least describe the manufacturing product (i.e. comprise the default parameters) and may optionally additionally describe manufacturing conditions, for example a desired output. Typical default parameters may comprise for example a width of the manufacturing product, a general material specification and/or a cutting angle of the scissors (cutting device). Some of the operating parameters of a recipe may also be combined as a recipe ID.

Operating parameters that define the recipe or would change it if changed cannot be modified during the manufacturing process for the manufacturing product, i.e. during the implementation of the recipe. The operating parameters of the recipe are provided, for example in a recipe dataset, at the start of the manufacturing process, for example loaded and/or entered from a data carrier and/or server. The operating parameters of a recipe, or generally operating parameters that cannot be changed during a manufacturing process, may be understood to be (some of the) manufacturing conditions or describe same.

A settable operating parameter does not directly have to be a control parameter (for example to be converted into control signals). On the contrary, more abstract settable operating parameters are also conceivable, from which the control device derives at least one, possibly also multiple, control parameters. In particular, the more abstract settable operating parameter may be more intuitively comprehensible to the operator, for example specify a correction that is then achieved specifically by one or more control parameters.

According to the invention, it is proposed to monitor manufacturing processes by means of cycle times which are recorded by means of at least one cycle time recording means. The cycle time recording means can in particular form part of the control device and evaluate control signals exchanged between control units and/or functional units of the control device, for example. Particularly preferably, the control device is configured as a central control device for controlling the entire manufacturing installation, i.e. as a superordinate control entity. Particularly preferably, the monitoring also relates to multiple or even all manufacturing components.

Cycle times are thus recorded by means of control signals, preferably with an accuracy in the millisecond range, for example with an accuracy of at least 10 to 1 ms. By evaluating the cycle times in measure conditions, which particularly advantageously refer to known values from previous and/or optimized manufacturing processes, in particular draw comparison therewith, deviations or anomalies in the current manufacturing process, as investigations in the context of the present invention have shown, can be detected particularly robustly, accurately and at an early stage. This kind of monitoring on the basis of the cycle times may also be understood as a self-diagnosis of the manufacturing installation. Deviations or anomalies are detected at an early stage and can be brought to the attention of the user, for example an operator, on the basis of the control measures and/or can be alleviated, in particular in a corrective manner, on the basis of the control measures, whether by compensation of the deviations, protection of manufacturing components or their individual-step components (for example by premature termination of the manufacturing process) and the like. Indications of the presence of the corresponding anomaly, in particular warning indications, can be output for example on output means of the operating device, for example by activating a signal lamp and/or warning indications in a user interface for control purposes.

The cycle times are preferably evaluated at least substantially in real time, i.e. with their presence, by the measure condition(s), such that a decision about a control measure to be carried out can be made promptly.

At least one of the at least one measure condition can also use a trained evaluation function of artificial intelligence, in particular when assessing more complex issues. Fundamentally known techniques of machine learning can be used in this case.

It has therefore been recognized, in general terms, that during the production of belt and carcass bands, a particularly large number of individual-step components of the manufacturing components and also the manufacturing components interact coordinatedly among one another highly accurately in a wide variety of ways, depending on the recipe, wherein cycle times, in particular with regard to the individual steps (substeps), which will be discussed in even more detail, react sensitively to deviations and can thus indicate them in a highly accurate and reliable manner. In particular, localization of the deviation is even possible in this way.

In one expedient development, provision can be made for at least one further recording means to be provided for recording at least one further manufacturing value describing the operation of the manufacturing installation, wherein at least one of the at least one measure condition additionally evaluates at least one of the at least one manufacturing value. By way of example, at least one of the at least one further manufacturing value can relate to a movement and/or a position of the processed material and/or the processed material itself and/or at least one processing condition, in particular a temperature. By way of example, recording means can comprise at least one sensor, but can also interrogate information internally within the control device. At least one of the at least one manufacturing value can also be an operating parameter, for example a default parameter of a current recipe and/or a settable operating parameter.

It is therefore conceivable to also additionally include other manufacturing values of the manufacturing installation in the monitoring process. While in principle measure conditions are (additionally) conceivable which relate only to at least one manufacturing value and serve for monitoring, it may also be expedient to evaluate at least one manufacturing value and at least one cycle time jointly by means of a measure condition. If, for example, it is known that the cutting process takes longer for some materials, this can be mapped against a specific manufacturing value when evaluating the measure condition. Known temperature dependences can also be mapped in measure conditions, for example, if a corresponding manufacturing value is additionally included. In this regard, manufacturing values allow an even more accurate analysis.

In this context, provision can be made particularly advantageously for the recording of the at least one cycle time and the at least one measure condition to be related to a recipe-forming set of operating parameters of the manufacturing installation defined for the manufacturing process. In other words, the monitoring can be carried out in a recipe-specific manner, such that in particular measure conditions can be related to manufacturing processes according to a specific recipe. This consideration of descriptions of a current manufacturing process allows once again significantly more accurate and more robust detection of deviations, i.e. anomalies, in the manufacturing process. By way of example, the control device can have a database in which it is possible to store, in a manner assigned to each recipe, which cycle times are to be recorded and/or which measure conditions are to be used and/or how these are to be parameterized.

In an expedient development of the present invention, provision can be made for the cycle time recording means to be configured, for the purpose of recording the cycle time, to interrogate two successive control signals, in particular readiness and/or trigger signals, of the at least one individual-step component and/or of the manufacturing component, and/or to determine at least one of the at least one cycle time as the duration of at least one of the individual steps. This last means in particular that the cycle time recording means is configured to determine at least one cycle time as a time period between two successive different control signals, in particular readiness and/or trigger signals, which delimit at least one individual step, during an action cycle. It is therefore proposed to use readiness and/or trigger signals used in the control device in any case for at least a portion of cycle times to be determined. That means that, in this respect, at least one of the at least one cycle time recording means can be designed, for example as a recording unit of the control device, to monitor control signals exchanged within the control device, in particular readiness and/or trigger signals, and to record, in particular log, the corresponding time when a control signal to be logged occurs. The difference between two such successive times then yields a cycle time, in particular as the duration of an individual step. In other words and put more generally, provision can be made for cycles of the manufacturing installation, i.e. standard sequences, to be defined as time segments with a start time logged when a control signal is present and an end time logged when a further control signal is present. These time segments, i.e. total-cycle cycle times, are then subdivided even further into individual steps which likewise have, preferably exclusively, start times and end times which are defined by the presence of control signals and which are to be logged. The cycle times recorded in this way are then evaluated in a superordinate controller. In this case, it is also possible particularly advantageously for the sum of all individual-step cycle times of a cycle to be provided as a total-cycle cycle time, which will be discussed in even more detail below. The division into individual steps and the recording, in particular logging, of cycle times for the individual steps enable a more accurate analysis as to where the anomaly is present. The individual steps are expediently defined in such a way that deviations from an expected cycle time, in particular for a recipe, can already be assigned to specific anomalies in the context of the evaluation. If, for example, an individual step is defined in which the material to be processed is intended to be raised magnetically by interaction with a magnetic element arranged below the material, typical deviations may occur as a result of slipping of the element arranged below the material, that is to say for example if the magnetic force does not directly “grip”. Conveying sections may, possibly, over a longer period of time, be associated with a poor grip of the conveying individual-step component and/or with material slipping back, and the like. It should also be pointed out at this juncture that individual-step components may not necessarily be assigned to a single individual step, rather it is entirely conceivable for an individual-step component to carry out a plurality of individual steps and/or to be involved in a plurality of individual steps. One example of this is a lifting apparatus of a cutting device or scissors and/or of a retraction system, which can be used for example both as a holding-up unit and as a holding-down unit in various individual steps. Furthermore, it should also be noted in general that in some cases individual-step components of other manufacturing components can also participate in a cycle of a manufacturing component and/or can supply or receive control signals. Consequently, the control signals need not necessarily originate from and/or be directed to the manufacturing component to be monitored.

Preferably, therefore, in the case of at least one cycle time related to at least one individual step, the monitoring unit can be configured for assigning an anomaly to at least one individual step and/or at least one measure condition can be formulated for indicating an anomaly to be assigned to at least one individual step upon fulfilment. In this case, however, it is quite possible to use more complex evaluations and/or measure conditions which, for example, may also take into account other individual steps of their cycle (and/or of an adjacent cycle) and the cycle times thereof, since anomalies in specific individual steps may also have effects on the cycle times of other individual steps. Measure conditions can be formulated at least partly in a targeted manner such that they are directed at the detection of anomalies in specific individual steps and/or individual-step components.

In this case, particularly advantageously, a hierarchy of the evaluation processes and/or measure conditions is also conceivable, wherein the superordinate evaluation processes and/or measure conditions relate to the total-cycle cycle time. In this regard, for example, provision can be made for firstly evaluating a measure condition which is related to the total-cycle cycle time and which indicates the presence of an anomaly upon fulfilment, wherein, upon fulfilment of the measure condition, subordinate measure conditions related to individual-step cycle times are evaluated in order to localize the anomaly in at least one individual step and/or one individual-step component-if possible. It should be pointed out here that this hierarchy can also be continued further, for example total times can be determined and can be evaluated for a plurality of successive cycles, for example entire manufacturing components or groups of manufacturing components. By way of example, a total time over all manufacturing components is also conceivable and recordable, wherein in the event of an anomaly in this a transition can then be made in the hierarchy step by step to subordinate total times, in particular total-cycle cycle times, and then to individual-step cycle times.

Exemplary embodiments can provide for at least one of the at least one readiness and/or trigger signal to be a completion signal from at least one supporting individual-step component, in particular a holding-up unit and/or a holding-down unit and/or a raising device and/or a positioning device, to a material-conveying and/or material-processing individual-step component, in particular a conveyor belt and/or a gripping device and/or a cutting means and/or a connecting means and/or a material-adding means, and/or to be a start signal for an individual-step component. Other examples of control signals that can be recorded in order to determine cycle times also comprise start signals of the control device and/or of another manufacturing component for the basic start of the cycle.

In a preferred embodiment, at least one of the at least one measure condition can be a limit value condition which compares at least one of the at least one cycle time with an assigned upper limit value and/or an assigned lower limit value. For fulfilment of the measure condition, an overshoot is necessary in the case of the upper limit value, and an undershoot in the case of the lower limit value. A check is thus made here to establish whether the cycle time lies within at least one expected limit. Various procedures are conceivable here in order to arrive at the limit values.

In this regard, in a first configuration variant of the present invention, provision can be made for at least one of the at least one limit value, in particular for at least one recipe, to be fixedly predefined. In this case, a comparison with permanently stored limit values is thus made in order to indicate anomalies. Such limit values can be for example limits which are set or determined theoretically during the design of the manufacturing installation, in particular for the respective recipe, and/or during test runs, in particular test runs on the part of the manufacturer. Such intervals in which the cycle time is intended to range are usually chosen to be somewhat wider, since local and/or current particularities cannot be taken into account. They are thus particularly suitable if empirical values are not yet available at the specific manufacturing installation, for example for the specific recipe.

In a second configuration variant, provision can additionally or alternatively be made for the monitoring device to have a determining unit for determining at least one learned limit value from among the at least one limit value in a learning phase of the current and/or of an at least recipe-like reference manufacturing process. Provision can thus be made for the at least one limit value to be determined, thus as it were learned, in at least one manufacturing process at the same manufacturing installation. Specifically, provision can be made for the learning phase for at least one learned limit value to be a sliding time window ending at the current time or at a predefined temporal distance before the current time and/or the learning phase for at least one learned limit value to be a time segment, beginning in particular after a start-up phase, at the beginning of the current manufacturing process or of the reference manufacturing process and/or a, at least after the start-up phase, complete reference manufacturing process, in particular the first of a recipe. For example, during the first pass of a manufacturing process for a recipe, if as yet no limit value or only the fixedly predefined limit value mentioned above is present, it is thus possible to monitor the scope within which cycle times range during a normally proceeding manufacturing process. In principle, it is preferred here to wait during a start-up phase, for example a specific number of cycles, in particular 5 to 30, in which, in particular with monitoring by a user, the manufacturing installation must run continuously before the stable, normal manufacturing state has been reached and can be used for learning limit values. In principle, such a start-up phase can also be set before the beginning of the monitoring. Expediently, however, the limit values can keep on being updated as long as the manufacturing installation runs in a stable manner. In this way, improvements, readjustments and the like brought about by the user, for example, can also be taken into account. Nevertheless, a certain temporal distance from the current time should then expediently be maintained, since some anomalies may form slowly and might therefore possibly be “concomitantly learned”, which can be avoided by the temporal distance. For example, the learning phase can always reach back to the end of the last successfully completed manufacturing process. It is particularly advantageous, in the learning phase, too, for the cycle times to be expediently recorded together with at least one, in particular the at least one, further manufacturing value in order to be able to relate them to the manufacturing conditions and other circumstances. In other words, the cycle times are preferably recorded, in particular also during the monitoring, in conjunction with all movements and sensor interrogations at the manufacturing installation. In this regard, especially if the measure conditions also interrogate manufacturing values, further improved and more accurate evaluations can be carried out. In general as well, however, a significant improvement in monitoring is already achieved by learning from preceding manufacturing sections, in particular of the same recipe, since it is possible to focus specifically on the normal state at a specific manufacturing installation.

Monitoring can indeed also be provided during a learning phase, that is to say that while the at least one learned limit value is being determined, for example currently recorded cycle times can also be monitored with regard to the predefined limit values according to the first configuration variant and/or measure conditions provided in some other way. By way of example, it is conceivable, in the case of a new recipe for which the at least one limit value is intended to be learned, to use measure conditions of a similar recipe, in particular of the most similar recipe, for which purpose a comparison hierarchy can be defined. If, for example, the desired width of the endless band to be produced differs only marginally from that of the current recipe, a high similarity can be assumed. Measure conditions of similar recipes can optionally be modified, for example can be attenuated as a function of a similarity measure with decreasing similarity. It goes without saying that if, for example owing to the use of a sliding time window, an update of limit values takes place, the previous limit values are, of course, in principle used for monitoring.

It should also be noted that it is advantageous in principle to analyze a profile of the cycle times over an evaluation time window. For example, a drift of cycle times over time may also indicate an anomaly. A trend that arises over an evaluation time window may indicate increasing wear or the like. Accordingly, measure conditions and possibly further evaluation processes can be configured to evaluate not just the current value of the cycle time but rather the profile over an evaluation time window, which can also be different from measure condition to measure condition.

Generally speaking, the recorded cycle times can also be evaluated in a useful manner over and above the detection of anomalies currently present. In this regard, one preferred configuration of the present invention can provide for the monitoring device furthermore to have an evaluation unit configured for evaluating recorded cycle times stored in a storage means of the monitoring device over at least one time period, in particular the profile of said cycle times, for determining optimized operating parameters of the manufacturing installation and/or for scheduling predictive maintenance. That means that the evaluation of the cycle times, in particular together with at least one manufacturing value, can also be used to improve, in particular optimize, the manufacturing process, since cycle times can also describe improvement potential besides anomalies. In addition, the cycle times, in particular trends in their temporal profile, can also be evaluated in respect of when maintenance might be expedient in the future, which maintenance can then be scheduled at an early stage without the possible occurrence of an (unplanned) outage of the manufacturing installation. Overall, in this way the cycle times are also supplied for further purposes, and thus used to afford multiple advantages. By way of example, it is possible to use in the evaluation unit, in a manner comparable with the measure conditions for anomalies, optimization conditions and/or maintenance conditions which can be assigned corresponding optimization and/or output measures for adapting (settable) operating parameters and/or for indicating maintenance to be scheduled.

In one development, the manufacturing installation can furthermore comprise a display device, in particular as part of the operating device, and the control device can be configured for at least partially outputting the at least one cycle time and/or information derived therefrom on the display device, in particular within a user interface for operating and monitoring the manufacturing installation. Specifically, provision can be made for example for the outputting to comprise displaying the current cycle time with at least one comparison value, in particular the upper and/or the lower limit value. Furthermore, the displaying can also comprise a profile of the cycle times, in particular also over a plurality of manufacturing processes as a respective average value. In this way, a user can also observe and monitor the cycle times and draw conclusions which may not or not yet be covered by measure conditions and/or the further evaluation, for example for optimization. In addition, said user continuously obtains an overview of the manufacturing installation and the extent to which the manufacturing process is proceeding within normal parameters.

As is generally known for generic manufacturing installations for belt band and/or carcass band, the manufacturing installation according to the invention can preferably also provide for the manufacturing components to comprise
an unwinding station for a starting band, in particular a cord band,
scissors for cutting band sections at a predefined angle and a predefined width from the starting band from the unwinding station,
a retraction device for conveying the starting band through the scissors,
a splicing device, in particular a butt splicer or an overlap splicer, for connecting the band sections cut by the scissors,
at least one winding station for the belt and/or carcass band, and
at least one conveying device.

A scissors table of the scissors can serve as material support, which can also be provided in other ways. In addition, the manufacturing installation can comprise at least one optional manufacturing component, for example a steadying roller and/or a repair belt. Further optional manufacturing components can comprise a slitter and/or at least one covering apparatus.

It has proved to be particularly advantageous if at least the retraction device and/or the scissors (cutting device) are/is a manufacturing component to be monitored. This is because in the case of the retraction device and/or the scissors, in particular in the interaction thereof, a plurality of individual steps succeed one another which each require readiness or other trigger signals and may indicate specific anomalies at many different points, if the individual steps of the cycle through which the retraction device and/or the scissors pass(es) are all correspondingly monitored by cycle times. For example, this involves initially beginning with a start signal indicating that the material is to be pulled through the scissors for a predetermined length (which can correspond to the recipe default parameter of material width). Before this can take place, however, even further individual steps are required. In this regard, next it is possible to wait for a readiness signal from the unwinding station, indicating that enough material to be pulled has been prepared in a loop. A next individual step can now be defined by the end time that a holding-down unit signals that the latter is in position, and thus the material is in the transfer position. Further individual steps can relate to the readiness, i.e. completed positioning, of a lifting apparatus and a holding-up unit. After the positioning of the lifting apparatus, pliers can grip the material, which can likewise be interrogated in exemplary embodiments. Optionally, in a further individual step, the positioning of a receiving device for further conveying of the cut-off material to the splicing device can then take place and the corresponding completion signal can be awaited. As the last individual step, the pliers can then actually pull the material through the scissors by the predetermined length, whereupon a readiness signal for cutting can be given to the scissors. After the removal of the cut-off material section has begun, the pliers then move forward again to the scissors in order then to wait for new material to be gripped in the next cycle. All of these control signals indicating triggers, a completion or a readiness and the like can now be recorded by the cycle time recording means, for example a recording unit of the control device, wherein the corresponding time stamp describing a start time or end time of an individual step is logged (time stamp). The cycle times are obtained on the basis of the differences, the total-cycle cycle time also being obtained as the difference between the first start time and the last end time. Consequently, a cycle for the retraction, i.e. in particular the retraction device and/or the group comprising retraction device and scissors, can relate to the partial manufacturing process of gripping and retraction of the material for a material section to be cut off by the scissors. Exemplary anomalies which can be detected by way of these cycle times, optionally together with at least one manufacturing value, on the basis of measure conditions comprise
incorrect blade cut of the scissors
wear of the spindles of the retraction device and/or scissors
necessary correction for setting the pliers
material feed not correct
holding-down system fault
incorrect section width
material slips back
wear on the pliers segment
user input errors in the case of operating parameters such as axial parameters of the retraction device and/or scissors and/or speeds of the retraction device and/or scissors.

Of course, other possibilities are also conceivable. The insights concerning wear can also be processed and/or obtained in the evaluation unit with regard to maintenance, for example by way of the maintenance condition.

The cycle time analysis is not limited to the retraction device and/or the scissors. For example, it is particularly advantageous if (further) cycle times of the scissors are also recorded in parallel with the retraction device (and/or the scissors), wherein at least one measure condition in each case evaluates at least one cycle time of the retraction device and of the scissors jointly in order to ascertain a specific anomaly and/or at least one cycle time of the scissors is determined on the basis of at least one control signal also used to determine a cycle time of the retraction device. Some control signals which have been used for defining individual steps and associated cycle times with respect to the retraction device can likewise be used for the scissors. In the case of the splicing device, too, different cycle times can be logged, for example the arrival of the material, the lowering of the actual splicing head and the like. It should also be noted that even if the cycle as a whole relates to an action on the material, i.e. band, not every individual step need act directly on the material.

It should be noted that, in the context of the invention, an interaction with control mechanisms can also be provided, for example insofar as the compensation of control deviations may influence expected cycle times. In this regard, for example, provision can be made for at least one of the at least one measure condition to be adapted depending on a control deviation of at least one control loop of the manufacturing installation. The type of adaptation, for example of the upper and lower limit values, can be ascertained empirically, for example, by virtue of the cycle times in the case of control deviations being recorded and evaluated in a manner assigned thereto, for example in the learning phase.

In addition to the manufacturing installation, the present invention also relates to a computer-implemented method for monitoring the operation of a manufacturing installation for belt and/or carcass band in the tire industry, wherein the manufacturing installation has a plurality of material-processing and/or material-conveying manufacturing components which are controllable depending on operating parameters, a control device for controlling the manufacturing components, and an operating device, wherein the control device has a monitoring device for monitoring the operation of at least one manufacturing component to be monitored from among the manufacturing components, comprising at least one individual-step component for carrying out individual steps of a cycle for acting on the material. According to the invention, the method has the following steps during a manufacturing process: recording a cycle time of the cycle on the at least one manufacturing component to be monitored, by way of at least one cycle time recording means, evaluating cycle times recorded by the cycle time recording means with regard to the fulfilment of at least one measure condition which indicates the presence of an anomaly in the manufacturing process, and carrying out at least one control measure which is assigned to a fulfilled measure condition and relates to an output of an indication of the presence of the corresponding anomaly and/or an intervention in the manufacturing process related to the anomaly.

All statements with regard to the manufacturing installation according to the invention can be analogously applied to the method according to the invention, and vice versa, and so the advantages already mentioned can also be obtained with the method.

A computer program according to the invention is loadable directly into a storage means of a control device of a manufacturing installation for belt and/or carcass band and has program means such that, when the computer program is executed on the control device, the latter is caused to carry out the steps of a method according to the invention. The computer program can be stored on an electronically readable data carrier according to the invention, which thus comprises control information stored thereon, which control information comprises at least one computer program according to the invention and is configured in such a way that when the data carrier is used in a control device of a manufacturing installation for belt and/or carcass band, said control information is designed to carry out a method according to the invention. The data carrier can be a non-transient data carrier, for example a CD-ROM.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 shows manufacturing components of a first exemplary embodiment of a manufacturing installation according to the invention for carcass band,

FIG. 2 shows manufacturing components of a second exemplary embodiment of a manufacturing installation according to the invention for belt band,

FIG. 3 shows manufacturing components of a third exemplary embodiment of a manufacturing installation according to the invention for carcass band,

FIG. 4 shows manufacturing components of a fourth exemplary embodiment of a manufacturing installation according to the invention for belt band,

FIG. 5 shows control and operating components for the first and second exemplary embodiments,

FIG. 6 shows a flowchart of one exemplary embodiment of the method according to the invention,

FIG. 7 schematically shows a first state diagram for explaining the method,

FIG. 8 schematically shows a second state diagram for explaining the method,

FIG. 9 schematically shows a third state diagram for explaining the method,

FIG. 10 schematically shows a fourth state diagram for explaining the method,

FIG. 11 schematically shows a fifth state diagram for explaining the method,

FIG. 12 schematically shows a sixth state diagram for explaining the method,

FIG. 13 schematically shows a seventh state diagram for explaining the method, and

FIG. 14 shows a possible display in the user interface.

### DETAILED DESCRIPTION OF THE INVENTION

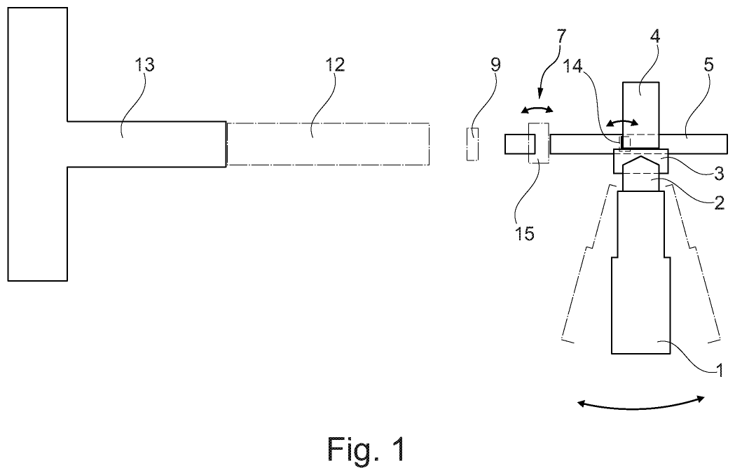

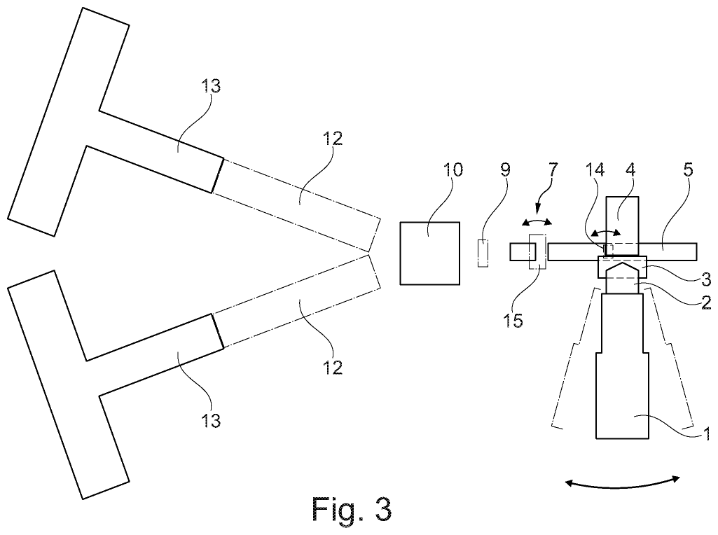

FIG. 1 and FIG. 3 show exemplary layouts for a carcass installation without and respectively with a slitter as a first and a third exemplary embodiment, respectively, of a manufacturing installation according to the invention.

The carcass installation comprises an unwinding station 1 from which the cord band to be processed is taken as a starting band. In the unwinding station 1, the material rolls to be processed are hung in a suitable frame and unwound. In this case, the cord web to be processed is separated from an intermediate layer (foil, linen or the like). This intermediate layer is used to prevent the material web, which is rubberized here, from sticking. To realize different cutting angles, the unwinding station 1 can be swiveled as explained, but this is not absolutely necessary. There are various embodiments with regard to such an unwinder. Single unwinders, in which a material roll is able to be hung, are known. In a double unwinder with a turntable, two material rolls are provided for hanging, one of which is processed, one of which is changed. In addition, a double unwinder with a shuttle frame for hanging two material rolls, one of which is processed, one of which is changed, is known. Furthermore, cassette unwinders, in which a material roll is hung in a cassette and the cassette is then transported into the unwinder, are known. This list is not exhaustive. The unwinding station 1 can form a material loop and can be kept available for withdrawal.

The swivelable unwinding station 1 is followed by a cutting device or scissors 3, the latter being used to cut the cord band coming from the unwinding station 1. The scissors 3 are used to cut cord band strips at a defined width and a defined angle. Various embodiments can be used as scissors 3:
Guillotine scissors with a fixed lower blade and an extendable/retractable upper blade,
Circular blade scissors with a fixed lower blade and a circular blade running along it, and
Scissors with a fast-rotating saw blade (similar to a circular saw blade).

Depending on the material to be processed, different scissor embodiments are used. The decisive factor here is which cord material (whether textile or steel cord) has to be cut and at what angle (carcass or belt installation types), wherein, in this example, scissors 3 are used for a carcass installation.

The material support 2 is connected to the unwinding station 1. If necessary, it swivels together therewith. The material to be processed lies on the material support 2 and is pulled, lying thereon, into the scissors 3. At the start of the material support 2 or above it, there is very often a conveying device that transports the start of the material into the scissors, for example a driven conveyor roller. This is necessary whenever the manufacturing installation is completely emptied and the start of a new material roll has to be inserted into the scissors 3, or if the material has been pulled back slightly from the scissors 3 in order to swivel the unwinding station 1.

The process after cutting is particularly relevant to the design of the scissors. In order to incorporate the cut material, i.e. the band sections, into the subsequent process with few processing steps, further manufacturing components or individual-step components of manufacturing components, such as for example bands and holding-up units, are used. These further manufacturing and/or individual-step components should be located as close as possible to the scissors 3 (which likewise form a manufacturing component). For this purpose, the material should be moved as little as possible (in particular in terms of a drop height) in order to process it further in a cut set-down position.

In order to convey the material through the scissors 3, a retraction device 4 is used as a manufacturing component in most cases. By way of example, a gripping apparatus (pliers) as an individual-step component must be used to move very close to the bottom blade. This requires a certain amount of space in order to avoid collisions with the upper blade (or circular blade). This results in different designs of the scissors 3.

The retraction device 4 is used to convey the material web into the scissors 3, or pulls the gripped cord band through the scissors 3, as described above. The scissors 3 furthermore have a transport belt that receives the cut cord band section and transports it out of the scissors 3. Such a conveyor can be in the form of a single conveyor belt, in the form of multiple conveyor belts or in the form of multiple conveyor belts with an interposed lifting device.

The cord band section is then passed on to a first conveying device in the form of a belt 5 of a splicing device 7, here an overlap splicer 14, and supplied to the actual splicing unit. For this purpose, a receiving device can also be provided, as described above with regard to DE 20 2005 011 692 U1. This first conveying device 5 can in principle also coincide with the conveying device that is assigned to the scissors 3, such that only one conveying device, which is then the first conveying device with respect to the overlap splicer 14, is located between the actual overlap splicer 14 and the scissors 3. The overlap splicer 14 is used to connect (purely mechanically, without the use of additives) the previously cut band sections. It can be swiveled at an angle in order to be able to process the band material at different angles.

Optionally, a further splicing apparatus in the form of a butt splicer 15 is also provided as part of the splicing device 7, which can be used in place of the overlap splicer 14, if this type of splicing is required.

A steadying roller 9, to be provided optionally, is arranged downstream of the overlap splicer 14 or its second conveying device (or the alternative butt splicer 15). This is merely a driven roller that transports the spliced-together cord band coming from the splicing device 7 to the next manufacturing component. In this case, the spliced-together cord band is counter-bent as a result of being transported through the steadying roller 9. The counter-bend causes the material to contract in the longitudinal direction. The background is thus to reduce the elongation of the material in the longitudinal direction during processing in the splicing device 7 according to the invention. During removal, the next band section is already cut in the scissors 3.

Downstream of the (optional) steadying roller 9, in the third exemplary embodiment according to FIG. 3, a slitter 10 is then provided as a further manufacturing component, which slitter divides the spliced-together cord band into two, in particular equal-sized, partial bands. By way of example, a cutting unit can be arranged on a frame and serves to separate the supplied spliced-together cord band into at least two cord band strips. Normally, two interacting circular blades are provided for this purpose. A control frame can furthermore be provided, which is able to be swiveled relative to the frame about a vertical swivel axis. The cord belt runs over the control frame. From the control frame, it reaches the region of the cutting unit, where it is divided into the two cord band strips. Other variations are also conceivable.

According to FIG. 1, the optional steadying roller 9 is followed by a likewise optional covering apparatus 12, and according to FIG. 3, the slitter 10 is followed correspondingly by two likewise optional covering apparatuses 12. In this manufacturing component, even further rubber strips, for example one to twelve pieces, are applied to the produced material web, i.e. the spliced-together, in the third exemplary embodiment also slitted, cord band strips. The application may be carried out from above and/or from below. Furthermore, the outer edges of the material web are often edged, i.e. a rubber strip is applied from the outer edge without or with an overhang and laid around the rubber edge in order to cover the cord threads exposed at the outer edge, which corresponds to the cutting edge.

In any case, one winding station 13 is provided in the case of FIG. 1, and two winding stations 13 in the case of FIG. 3. In these manufacturing components, the, optionally slitted, cord band strips are wound back onto spools with an intermediate layer that prevents sticking. In this case too, there are various embodiments, ranging from fairly simple single winders, in which the material has to be cut manually and wound on a new roll, to fully automatic winders, in which no operator intervention whatsoever is necessary for material handling.

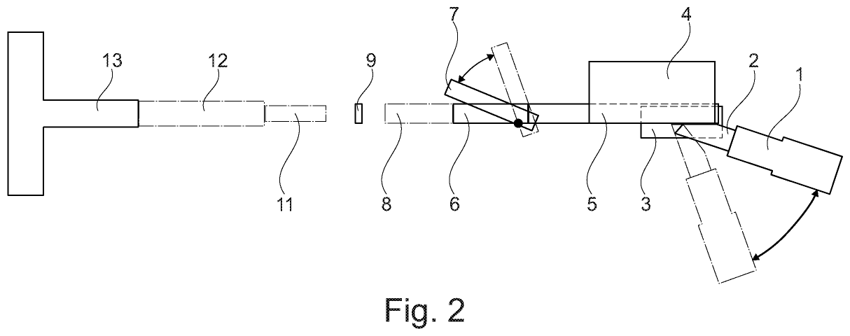

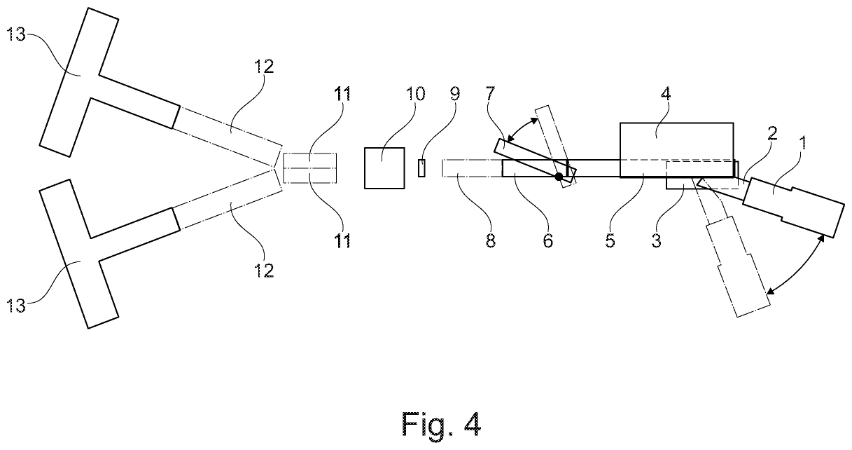

FIG. 2 and FIG. 4 show exemplary layouts of belt installations one without and one with a slitter 10 as second and fourth exemplary embodiments of a manufacturing installation according to the invention. Manufacturing components that have already been described in the layouts in FIG. 1 and FIG. 3, where provided, have been provided with the same reference signs, and their function is the same as described for FIG. 1 and FIG. 3.

Provision is made of an unwinding station 1, which however, here, is able to be swiveled by a significantly larger angle. The unwinder can be of any type, as already described above.

The unwinding station 1 is followed by the scissors 3. The material support 2 is connected to the unwinding station 1. If necessary, it swivels together therewith.

The scissors 3 are used to cut cord band strips at a defined width and a defined angle. The types of scissors described above can be used as scissors 3, provided that they are suitable for belt installations.

The scissors 3 are followed by a retraction device 4 such as has been described above. This is used to convey the material web into the scissors 3, or pulls the gripped starting band through the scissors 3, as described above.

The cord band section is then passed on to the first conveying device (in the form of a belt 5) of a splicing device 7, which can comprise an overlap splicer or butt splicer, and supplied to the corresponding actual splicing apparatus. The splicing apparatus is able to be swiveled by a considerable angle in order to set the required splicing angle. It furthermore has a removal belt 6 as a conveying device, using which the spliced-together cord band is supplied to the downstream manufacturing component.

A belt 8 for manual splicing, i.e. for manual connection of the band sections, can optionally be disposed downstream of the splicing device 7. During this manual processing, the automatic splicing device 7 is out of service. Such manual splicing is required for specific cord band materials, very narrow section widths or at the request of a customer. Optionally, a steadying roller 9 can also be provided in the second exemplary embodiment.

In the exemplary embodiment in FIG. 4, a slitter 10 follows as a further manufacturing component. The separation of the spliced material web achieved using the slitter 10 leads to two winding stations 13 having to be provided in this case, and a covering apparatus 12 and/or a repair belt 11 can each optionally be disposed upstream of each thereof. In the case of FIG. 2 without a slitter 10, these manufacturing components are required only once. If faults in the band are detected, they can be repaired by means of the repair belt 11.

Although the cord band is conveyed from right to left in this illustration and also those that follow, it is of course also possible to design the layout with a reverse, mirrored design, i.e. to transport the cord band from left to right. All manufacturing components described as optional can be provided in different combinations together with the essential manufacturing components. For this reason, different layouts can be created from all the manufacturing components described.

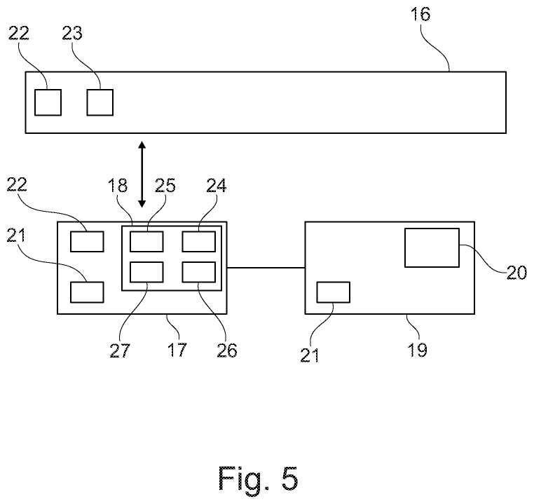

FIG. 5 schematically shows the control, operating and monitoring structure of the manufacturing installation, i.e. in particular the belt installation or the carcass installation. In addition to the arrangement 16 of manufacturing components, the manufacturing installation has a control device 17, which in this case comprises a monitoring device 18 and optionally further components. The operation of the manufacturing components of the arrangement 16 can be controlled via the control device 17. The control device 17 is also connected to an operating device 19, via which user inputs made by a user/an operator can be received. The operating device 19 also has a display device 20, in the present case a display or screen. It should be noted that a user interface can also be provided via Internet access or the like. The control device 17 and the operating device 19 can be designed to be at least partially integrated, that is to say that components of the control device 17 can be installed in structural units or assemblies of the operating device 19, and vice versa.

The control device 17 and/or the operating device 19 furthermore comprise(s) a storage means 21, in which, in addition to other information, operating parameters (or specifically the values thereof), cycle times and manufacturing values (which can at least partly correspond to values of operating parameters) and measure conditions can also be stored in the present case. In this respect, it should first be noted that a manufacturing process for the production of a specific manufacturing product is usually based on what is known as a recipe, which comprises default parameters describing the manufacturing product (for example cutting angle of the scissors 3, desired width) and possibly further operating parameters, for example an output to be achieved. The operating parameters described by the recipe of the current manufacturing process usually cannot be changed during the manufacturing process. By way of example, they can be entered on the operating device 19 and/or read out from a data carrier and/or server.

In the context of a manufacturing process carried out for the implementation of a specific recipe, there are also settable operating parameters, i.e. for example operating parameters that can be chosen by the user. Settable operating parameters can be adapted automatically during operation by the control device 16, for example by way of closed-loop control operations, but also at least in part by the operator by way of the operating device 19. Changes to the operating parameters, for example starting from a base set for a recipe, are in principle used to optimize the manufacturing process or the manufacturing product.

The control device 17 and its control mode are superordinate, i.e. encompass all manufacturing components of the arrangement 16. At least one of the settable operating parameters concerns multiple or even all manufacturing components, for example a conveying speed of the band material through the arrangement 16.

The monitoring device 18 serves to monitor the operation of the manufacturing installation during a manufacturing process according to a specific recipe. It uses, as input data, cycle times recorded by at least one cycle time recording means 22 for at least one manufacturing component to be monitored, wherein in the present case at least the unwinding station 1, the scissors 3, the retraction device 4 and the splicing device 7 are manufacturing components to be monitored. Further manufacturing components, such as for example the slitter 10, the covering apparatus 12, the repair belt 11 and the like, can of course also be monitored.

In the exemplary embodiments discussed in more specific detail here, the cycle time recording means 22 is formed by a recording unit of the control device 17 and interrogates control signals, for example readiness signals, trigger signals and the like, from manufacturing components and/or their individual-step components, the time stamp of which describes the start times and/or end times of cycle times. Start times and/or end times can also be recorded at least in part by cycle time recording means of the arrangement 16 itself, for example sensors and/or other transmitters.

In this connection, it should already be noted that manufacturing components undergo a repeating respective cycle during the manufacturing process, for example the cutting device/scissors 3 repeatedly sever material sections, the retraction device 4 repeatedly pulls material through the scissors 3 and the splicing device 7 repeatedly splices material sections together to form the endless band. These cycles are each formed by individual steps, wherein in the present case a cycle time is determined for each of these individual steps. That means that the sum of the cycle times of the individual steps (individual-step cycle times) corresponds to the total-cycle cycle time, i.e. the duration of a cycle. In this case, the individual steps are carried out in particular by individual-step components of the manufacturing components, in this case the retraction device 4 and the scissors 3. For example, pliers or a pliers arrangement can be assigned as an individual-step component of the retraction device 4, and a lifting device and a holding-up unit can be assigned as an individual-step component of the scissors 3. The assignment can be effected functionally or structurally, wherein the manufacturing component to which an individual-step component is assigned is ultimately not relevant to the control structure and procedure according to the invention.

Optionally, in addition to the cycle time recording means 22, further recording means 23 can also be provided, which are designed to record at least one manufacturing value which is to be evaluated together with at least one of the cycle times. Manufacturing values can be for example operating parameters that are present or used in the control device 17, but can also describe manufacturing circumstances recorded by sensors, for example temperatures, movements and positions of the material, processing conditions (for example a temperature) and the like.

In order to be able to evaluate the recorded cycle times, the monitoring device 18 of the control device 17 in the present case firstly comprises a monitoring unit 24. The monitoring unit 24 checks the fulfilment of measure conditions, which each evaluate at least one cycle time and, upon fulfilment, indicate the presence of an anomaly in the manufacturing process. In this case, each measure condition is assigned at least one control measure, which is performed by a measure unit 25 of the monitoring device 18 upon fulfilment of the measure condition. The at least one control measure can relate for example to the output of an indication of the presence of the corresponding anomaly, for example a warning indication, but also an intervention in the manufacturing process related to the anomaly, for example the adaptation of a settable operating parameter, the omission of an optional individual step or, in extreme cases, an emergency stop, i.e. an at least temporary and/or partial interruption of the manufacturing process.

The monitoring device 18 also allows a further-reaching evaluation of the cycle times in an evaluation unit 26. The latter evaluates the cycle times in respect of whether predictive maintenance is necessary, for which purpose for example at least one maintenance condition, which preferably evaluates a profile of cycle times, can be checked. For example, the presence of at least one drift of at least one cycle time can be checked. Upon fulfilment of the maintenance condition, the predictive maintenance is scheduled. However, the cycle times are also evaluated in the evaluation unit 26 for the purpose of optimizing the manufacturing process, for example for adapting set operating parameters of the current manufacturing process and/or future manufacturing processes of the same recipe.

It should be noted in general that any evaluation in the monitoring device is carried out in a recipe-related manner, that is to say that cycle times, measure conditions and/or maintenance conditions/optimization processes to be recorded are all formulated for a specific recipe.

Specifically, provision can be made here for example for using predefined measure conditions (and optionally evaluation parameters of the evaluation unit 26) firstly for a recipe for which as yet no manufacturing process has been carried out on the manufacturing installation, for example on the basis of test runs, other manufacturing installations and/or similar recipes. Since measure conditions can be in particular at least in part limit value conditions which involve comparing at least one of the at least one cycle time to be evaluated with an upper and/or a lower limit value, predefined limit values can describe for example fundamentally expected intervals for specific cycle times.

In the exemplary embodiments described here, however, provision is made for learning the normal sequence of the corresponding manufacturing process, if appropriate also continuously, at the specific manufacturing installation for a specific recipe, in order to be able to detect anomalies particularly accurately, reliably and robustly. For this purpose, in a learning phase-optionally with parallel monitoring on the basis of the predefined measure conditions-the cycle times, optionally with the respective manufacturing values, are recorded. The learning phase can comprise for example at least one part of a reference manufacturing process which begins after a start-up phase, optionally the entire first manufacturing process of a specific recipe (without a start-up phase). By way of example, the beginning of the learning phase may necessitate that at least a predetermined number of cycles have been run through without termination/restart, in particular at least ten splicing processes have been carried out without termination.

However, a sliding time window as a learning phase is also conceivable in the case of continuous learning, although a predefined temporal distance from the current time should be maintained in order to avoid learning drifts that indicate an anomaly. By way of example, after confirmation that that has proceeded normally, the preceding manufacturing process of the same recipe can always be evaluated in order to determine or update the suitable measure conditions, in particular the limit values. It should be noted that if limit values are used, these may be dependent for example on a manufacturing value that is likewise to be evaluated by way of the respective measure condition. The determination of measure conditions in general and limit values in particular can be carried out by a determining unit 27 of the monitoring device 18.

Expediently, measure conditions can be formulated in such a way that a specific conclusion is also obtained which describes the detected anomaly in more detail. That means that, in the case of specific deviations/violated limit values, it is possible for example to deduce specific errors or other anomalies more accurately. This is possible in an expedient and more detailed manner in particular on the basis of the division of the cycle into individual steps and the determination of cycle times for these individual steps. It may also be expedient to organize measure conditions hierarchically, for example firstly to check, for the total-cycle cycle time, whether the presence of an anomaly is generally indicated, following which subordinate measure conditions seek to classify or localize this anomaly more accurately.

It should also be noted that, even in general terms, particular advantages may be afforded if, at least for manufacturing components which have cycles proceeding at least partly in parallel and/or which interact functionally, at least one measure condition also evaluates at least one cycle time of each of the two manufacturing components, since this can contribute to an even more accurate assignment and/or classification of a detected anomaly. This can relate to the retraction device 4 and the scissors 3, for example. A joint consideration of cycle times on more than two manufacturing components is also conceivable. In addition, it should be pointed out that for the purposes of the integration already mentioned, for example the units 22, 24, 26 and 27 can be implemented in a structural unit or assembly which is assigned to the operating device 19 and can contain the display device 20, for example.

One exemplary embodiment of the method according to the invention for monitoring the operation of the manufacturing installation will now be discussed below, focus being placed on the retraction device 4, which can also use individual-step components of the scissors 3, for which possible individual steps are illustrated purely by way of example. Of course, it is also possible in this respect to apply a wide variety of modifications, known in principle in the prior art, with regard to the construction of the retraction device 4 and the specific individual steps. In other words, the specific example presented here should be understood to be purely illustrative.

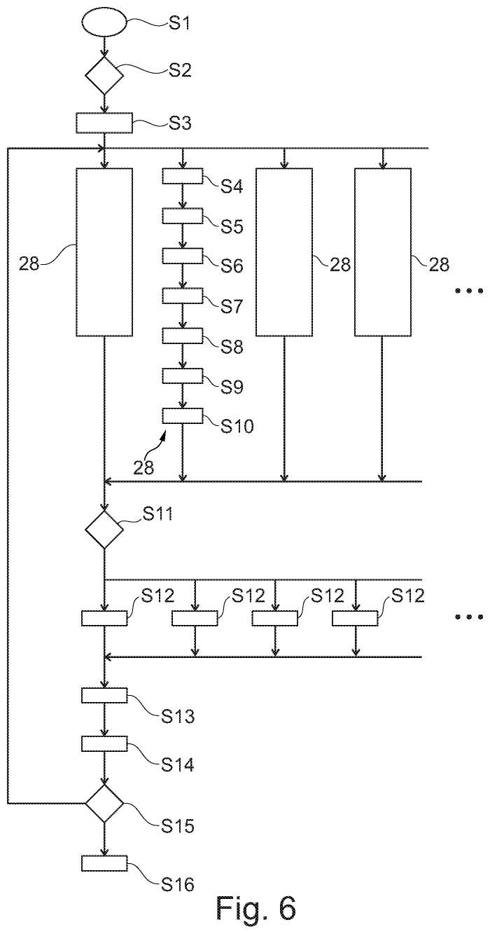

As shown in FIG. 6, in a step S1 a new manufacturing process begins for a specific recipe, which is also correspondingly logged, i.e. in particular stored in the storage means 21. In the present case, it is assumed that measure conditions, in particular learned limit values, are already present for this recipe.

In a step S2, a check is then made to establish whether the manufacturing installation is running in a stable manner, and hence a start-up phase is completed. For this purpose, it is necessary that ten cycles have been run through without interruption, i.e. in particular ten splices have been produced without interruption.

If this is the case, the monitoring, i.e. in particular also the recording and evaluation of cycle times, is enabled in a step S3. If ten splices without interruption is not accomplished, the method is begun again anew until this is accomplished.

Thus, in what follows then the cycle times are recorded by means of the cycle recording means 22 and manufacturing values are recorded in parallel by means of the further recording means 23. This is shown in more specific detail only by way of corresponding steps S4 to S10 for the retraction device 4, and otherwise abstracted by way of step blocks 28 for the sake of simplicity. Step blocks 28 are additionally provided in the present case at least for the unwinding station 1, the scissors 3 and the splicing device 7, preferably also for further manufacturing components.

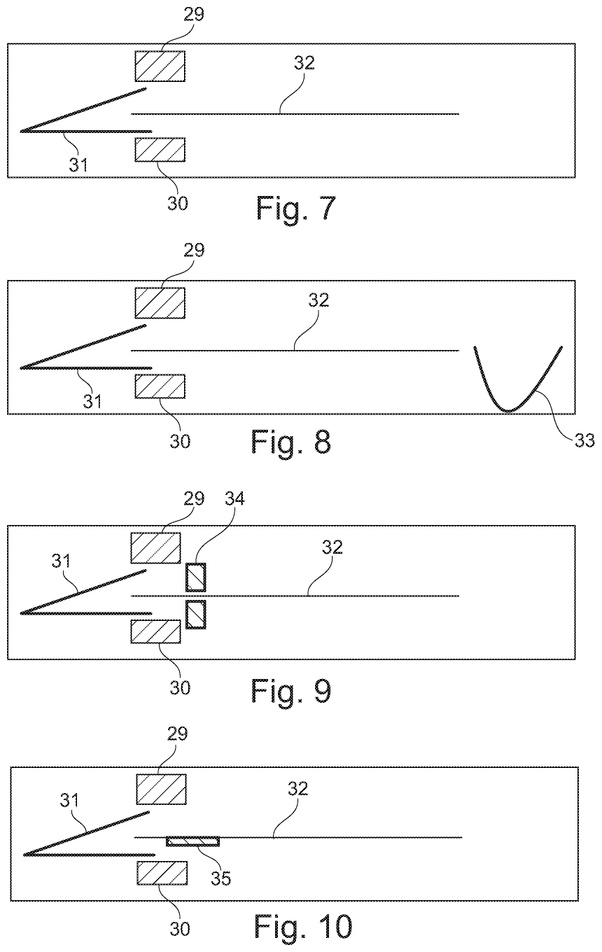

In a step S4 in the step block 28 for the retraction device 4, a general start signal/trigger signal is firstly recorded, which for each cycle after the first cycle can indicate for example that pliers or a pliers arrangement has been moved into a position close to the cutting unit of the scissors, and the time stamp thereof is logged as the start time of the first individual-step cycle time. The state at this start time is explained in more detail schematically by FIG. 7, wherein, in order to simplify the illustration, only the upper blade 29 and the lower blade 30 of the scissors 3, a pliers arrangement (pliers for short) 31 of the retraction device 4 and the material 32 are indicated in abstract form.

The general start signal instructs the retraction device 4 to pull material through the scissors 3 by a predetermined length, which is determined by the recipe default parameter of the width, for which purpose preparatory individual steps are necessary, however. Consequently, the start signal simultaneously acts as a trigger signal for the unwinding station 1 or a corresponding individual-step component (“letoff”) of the unwinding station 1 in order to provide a sufficient amount of material in a loop. Once this has taken place, the latter sends a completion signal or readiness signal, the time stamp of which is stored, in a step S5, as the end time of the first individual step and the start time of the second individual step once again by the cycle time recording means 22, in particular the recording unit. At this time, the first cycle time for the first individual step can already be provided in principle.

The corresponding state is once again shown purely schematically and abstractly in FIG. 8, where the loop 33 formed is now additionally illustrated. In this case, an external individual-step component of the unwinding station 1 thus also participates in the work of the retraction device 4.

The readiness signal of the unwinding station 1 is considered to be a trigger signal for an individual-step component of the retraction device 4 and/or of the scissors 3, for example a lifting apparatus also acting as a holding-down unit, in order to move this individual-step component into a transfer position. If this is the case, the individual-step component then sends a corresponding readiness signal, the time stamp of which is in turn logged in step S6. The corresponding time forms the end time of the second individual step and the start time of the third individual step.

FIG. 9 illustrates the corresponding state with the individual-step component 34 as a holding-down unit in position.

In the third individual step which then follows, a control signal (readiness signal) of an individual-step component acting as a holding-up strip is awaited, and the latter in this third individual step is consequently moved into a desired position, for example at the current level of the material 32. The resulting state is indicated in FIG. 10, where it should be noted that the individual-step component 35 shown in abstract form therein corresponds in many cases to the individual-step component 34, i.e. to the lifting apparatus already mentioned. The time at which the readiness signal “holding-up strip in position” is present is logged as the end time of the third individual step in step S7 and also serves as the start time for the fourth individual step.

In the fourth individual step, a holding-up unit of an individual-step component 36 is moved into position, wherein the reaching of this position behind the scissors 3 is in turn indicated by a corresponding readiness signal. In the present case, this fourth individual step also includes the fact that the pliers 31 grip the material 32 (which has been raised in the individual step before), although this can also be used as a separate individual step.

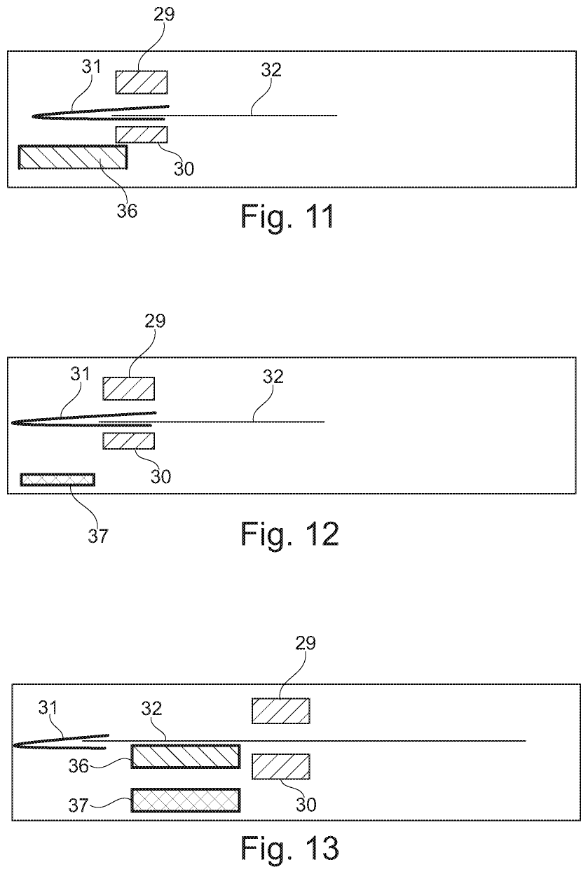

The resulting state is once again shown schematically and abstractly in FIG. 11, now with the closed pliers 31 and the individual-step component 36 acting as a holding-up unit. The corresponding readiness signal of the individual-step component 36 or the time stamp of the presence is stored, in a step S8, as the end of the fourth individual step and the beginning of the fifth individual step.

In the fifth individual step, the conveyor belt 37, which also forms an individual-step component, is then also positioned with respect to the splicing device 7, the completion likewise being communicated by a corresponding readiness signal. The corresponding time is logged as the end time of the fifth individual step in step S9. The result is shown schematically in FIG. 12.

In the sixth individual step, having begun with the readiness signal of the conveyor belt 37, the material 32 is then finally retracted through the scissors 3 via the individual-step component 36 and the conveyor belt 37, for example by the pliers 31 being moved accordingly by means of a crossmember. The completion of this individual step is also communicated as a control signal and serves in particular as a trigger signal for the cut by means of the scissors 3. The resulting state is shown schematically in FIG. 13. The trigger signal is stored, in step S10, as the end time of the sixth individual step.

After cutting and removal, the pliers 31 can be moved back into the position shown in FIG. 7, which is indicated by the corresponding start signal or readiness signal in step S4 at the beginning of a new cycle.

In a step S11, a check is then made to establish whether there is a sufficient amount of information available for the evaluation, wherein an evaluation can in principle also already take place during a cycle and there need not necessarily be any waiting for the cycle to be completed.

In respective steps S12, the monitoring unit 24 then evaluates the cycle times thus recorded for the various manufacturing components, optionally together with at least one manufacturing value, by way of the measure conditions. In this case, each step S12 can process the measure conditions assigned to a manufacturing component to be monitored. In this case, what has already been stated above is applicable concerning the hierarchical structure of the evaluation and concerning the possibility of cycle times of different manufacturing components also being taken into account in individual measure conditions.

In a step S13, the measures of the fulfilled measure conditions, if present, are then carried out by the measure unit 25. For example, warning indications are output and/or operating parameters of the manufacturing process are adapted.

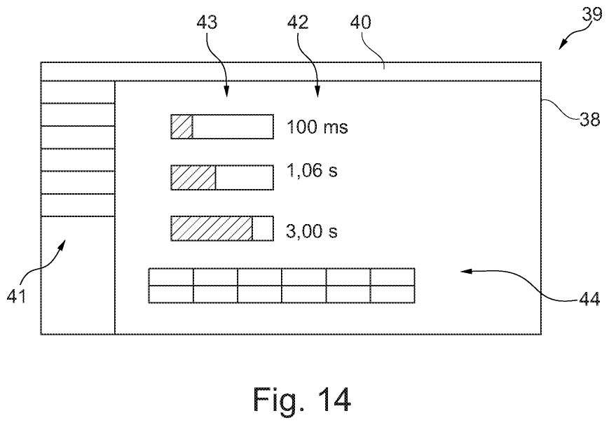

In step S14, an output takes place on the display device 20, where cycle times and associated information can also be output within a user interface. An exemplary representation 38 of a user interface 39 is shown schematically in FIG. 14. Elements of less relevance to the procedure described here, such as a status bar 40 and a menu 41, will not be discussed in more specific detail.

For a selected cycle time, for example a cycle time assigned to an individual step or a total-cycle cycle time of a manufacturing component to be monitored, the following are displayed in the upper region of the representation 38 as numbers 42 and bar charts 43 from top to bottom:
the lower limit value, learned in the present case, for the cycle time,
the last recorded, currently present cycle time, and
the upper limit value, learned in the present case, for the cycle time.

It is easily discernible to the operator that the current cycle time, as desired, lies between the lower and upper limit values. It can be displayed green, for example.

In the lower region of the representation 38, a table 44 is presented, which reproduces already recorded cycle times from previous cycles and/or manufacturing processes of the same recipe for further information, for example together with further information such as recording times and the like.

Returning to FIG. 6, a check is made in a step S15 to establish whether the manufacturing process has been completed or whether still further cycles will follow. If still further cycles follow, the method returns to the step blocks 28. However, if the manufacturing process has ended, further evaluations of the recorded cycle times with regard to the optimization of manufacturing processes with the recipe and/or predictive maintenance to be scheduled can be carried out in step S16 by means of the evaluation unit 26, as described. In principle, it is of course also conceivable to carry out such evaluation processes already during a manufacturing process, since it is then possible for example to directly observe the effects of adapted operating parameters on the cycle times and the manufacturing values, for example during the optimization, and for example to carry out optimization processes by varying operating parameters.

While specific embodiments of the invention have been shown and described in detail to illustrate the inventive principles, it will be understood that the invention may be embodied otherwise without departing from such principles.

We claim:

1. A manufacturing installation for belt and/or carcass band in the tire industry, having a plurality of material-processing and/or material-conveying manufacturing components which are controllable depending on operating parameters, a control device for controlling the manufacturing components, and an operating device, wherein the control device has a monitoring device for monitoring the operation of at least one manufacturing component to be monitored from among the manufacturing components, comprising at least one individual-step component for carrying out individual steps of a cycle for acting on the material, wherein at least one cycle time recording means for recording a cycle time of the cycle is provided on the manufacturing component to be monitored, and the monitoring device has:
a monitoring unit for evaluating cycle times recorded by the cycle time recording means with regard to the fulfilment of at least one measure condition which indicates the presence of an anomaly in the manufacturing process, and
a measure unit for carrying out at least one control measure which is assigned to a fulfilled measure condition and relates to an output of an indication of the presence of the corresponding anomaly and/or an intervention in the manufacturing process related to the anomaly.

2. The manufacturing installation according to claim 1, wherein at least one further recording means is provided for recording at least one further manufacturing value describing the operation of the manufacturing installation, wherein at least one of the at least one measure condition additionally evaluates at least one of the at least one manufacturing value.

3. The manufacturing installation according to claim 2, wherein at least one of the at least one further manufacturing value relates to a movement and/or a position of the processed material and/or at least one processing condition, in particular a temperature.

4. The manufacturing installation according to claim 1, wherein the recording of the at least one cycle time and the at least one measure condition are related to a recipe-forming set of operating parameters of the manufacturing installation defined for the manufacturing process.

5. The manufacturing installation according to claim 1, wherein the cycle time recording means is configured, for the purpose of recording the cycle time, to interrogate two successive control signals, in particular readiness and/or trigger signals, of at least one of the at least one individual-step component and/or at least one of the at least one manufacturing component, and/or to determine at least one of the at least one cycle time as the duration of at least one of the individual steps.

6. The manufacturing installation according to claim 5, wherein, in the case of at least one cycle time related to at least one individual step, the monitoring unit is configured for assigning an anomaly to at least one individual step and/or at least one measure condition is formulated for indicating an anomaly to be assigned to at least one individual step upon fulfilment.

7. The manufacturing installation according to claim 1, wherein at least one of the at least one measure condition is a limit value condition which compares at least one of the at least one cycle time with an assigned upper limit value and/or an assigned lower limit value.

8. The manufacturing installation according to claim 7, wherein at least one of the at least one limit value, in particular for at least one recipe, is fixedly predefined.

9. The manufacturing installation according to claim 7, wherein the monitoring device has a determining unit for determining at least one learned limit value from among the at least one limit value in a learning phase of the current and/or of an at least recipe-like reference manufacturing process.

10. The manufacturing installation according to claim 9, wherein the learning phase for at least one learned limit value is a sliding time window ending at the current time or at a predefined temporal distance before the current time and/or the learning phase for at least one learned limit value is a time segment, beginning in particular after a start-up phase, at the beginning of the current manufacturing process or of the reference manufacturing process and/or a, at least after the start-up phase, complete reference manufacturing process, in particular the first of a recipe.

11. The manufacturing installation according to claim 1, wherein the monitoring device furthermore has an evaluation unit configured for evaluating recorded cycle times stored in a storage means of the monitoring device over at least one time period, in particular the profile of said cycle times, for determining optimized operating parameters of the manufacturing installation and/or for scheduling predictive maintenance.

12. The manufacturing installation according to claim 1, wherein it furthermore comprises a display device and the control device is configured for at least partially outputting the at least one cycle time and/or information derived therefrom on the display device, in particular within a user interface for operating and monitoring the manufacturing installation.

13. The manufacturing installation according to claim 12, wherein the outputting comprises displaying the current cycle time with at least one comparison value, in particular the upper and/or the lower limit value.

14. The manufacturing installation according to claim 1, wherein the manufacturing components comprise
an unwinding station for a starting band, in particular a cord band,
scissors for cutting band sections at a predefined angle and a predefined width from the starting band from the unwinding station,
a retraction device for conveying the starting band through the scissors,
a splicing device, in particular a butt splicer or an overlap splicer, for connecting the band sections cut by the scissors,
at least one winding station for the belt and/or carcass band, and
at least one conveying device.

15. The manufacturing installation according to claim 14, wherein at least the retraction device is a manufacturing component to be monitored.

16. A computer-implemented method for monitoring the operation of a manufacturing installation for belt and/or carcass band in the tire industry, wherein the manufacturing installation has a plurality of material-processing and/or material-conveying manufacturing components which are controllable depending on operating parameters, a control device for controlling the manufacturing components, and an operating device, wherein the control device has a monitoring device for monitoring the operation of at least one manufacturing component to be monitored from among the manufacturing components, comprising at least one individual-step component for carrying out individual steps of a cycle for acting on the material, characterized in that the method comprises the following steps during a manufacturing process:
recording a cycle time of the cycle on the at least one manufacturing component to be monitored, by way of at least one cycle time recording means,
evaluating cycle times recorded by the cycle time recording means with regard to the fulfilment of at least one measure condition which indicates the presence of an anomaly in the manufacturing process,
carrying out at least one control measure assigned to a fulfilled measure condition, which is assigned to a fulfilled measure condition and relates to an output of an indication of the presence of the corresponding anomaly and/or an intervention in the manufacturing process related to the anomaly.

17. A computer program which, when executed on a control device of a manufacturing installation for belt and/or carcass band in the tire industry, causes it to carry out the steps of a method according to claim 16.

18. An electronically readable data carrier on which a computer program according to claim 17 is stored.
